(19) United States
(12) Patent Application Publication
(10) Pub. No.: US 2014/0238959 A1
(43) Pub. Date: Aug. 28, 2014

(54) PROCESSING SYSTEM

(71) Applicant: AU Optronics Corporation, Hsin-Chu (TW)

(72) Inventors: Yu-Hung TAI, HSIN-CHU (TW); Meng-Chuan WEN, Taichung City (TW); Yi-Jung CHIU, HSIN-CHU (TW); Chung-Wei LEE, HSIN-CHU (TW); Shan-Lung CHU, Taichung City (TW)

(73) Assignee: AU Optronics Corporation, Hsin-Chu (TW)

(21) Appl. No.: 14/078,938

(22) Filed: Nov. 13, 2013

(30) Foreign Application Priority Data
Feb. 25, 2013 (CN) 201310058770.7

(51) Int. Cl. B23K 26/30; B23K 37/04; B23K 26/02

(52) U.S. Cl. CPC B23K 26/422; B23K 26/02; B23K 37/04
USPC 219/121.6; 269/58; 269/14; 269/21

(57) ABSTRACT

A processing system includes a rotary stage, at least one shaft, a rotation driver, a plurality of loading platforms, and a plurality of processing devices. The rotary stage includes two opposite end surfaces and a plurality of loading surfaces between the end surfaces. The shaft connects the end surfaces of the rotary stage. The rotation driver connects the shaft. The loading platforms are respectively disposed on the loading surfaces of the rotary stage. The processing devices are respectively disposed corresponding to the loading platforms.

### RELATED APPLICATIONS

This application claims priority to Chinese Application Serial Number 201310058770.7, filed Feb. 25, 2013, which is herein incorporated by reference.

### BACKGROUND

1. Technical Field

Embodiments of the present invention relate to a processing system.

2. Description of Related Art

In a typical laser processing system, the objects to be processed are placed on a circular platform. The circular platform is rotatable, so that the objects can be moved to different workstations for processing. For example, the objects can be moved in sequence to a load/unload workstation, an alignment workstation, a laser cutting workstation and a dust cleaner workstation, and each of the workstations is equipped with a corresponding specialty machine. For example, the load/unload workstation can be provided with a loading machine and a unloading machine, and the laser cutting workstation can be provided with a laser source, so as to cut the objects and obtain desired patterns.

Because the circular platform is big, the processing system requires a large space, which is unfavorable for the plant planning and construction. Further, if the amount of the objects to be processed is increased, the size of the circular platform has to be increased. In the condition of the circular platform with an increased diameter, the displacement of the objects near the edge of the platform would be different from which near the center of the platform, thereby deteriorating the processing accuracy.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present invention provide a polyhedral processing stage, which utilizes different surfaces of the polyhedron to support the objects to be processed, so that the space for processing can be reduced.

In accordance with one embodiment of the present invention, a processing system includes a rotary stage, at least one shaft, a rotation driver, a plurality of loading platforms and a plurality of processing devices. The rotary stage includes two opposite end surfaces and a plurality of loading surfaces between the end surfaces. The shaft is connected to the end surfaces of the rotary stage. The rotation driver is connected to the shaft. The loading platforms are respectively disposed on the loading surfaces of the rotary stage. The processing devices are respectively disposed adjacent to the loading platforms.

When the rotary stage rotates, the upward loading surface can rotate from the upward direction to the rightward (or leftward, alternatively) direction, and then, the loading surface can rotate to the downward direction, and then, the loading surface can be rotated to the leftward (or rightward, alternatively) direction, and then, the loading surface can rotate back to the upward direction. Therefore, the loading surface can rotate to different level heights, rather than rotating on a constant level height, so that the space for processing can be reduced.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a side view of a processing system in accordance with one embodiment of the present invention;

FIG. 2 is a perspective view of the rotary stage of FIG. 1;

FIG. 3 is a perspective view of the rotation driver of FIG. 2;

FIG. 4 is a perspective view of the interior of the rotary stage in accordance with one embodiment of the present invention;

FIG. 5 is a perspective view of the loading platform in accordance with one embodiment of the present invention;

FIG. 6 is a front view of the interior of the rotary stage in accordance with one embodiment of the present invention;

FIG. 7 is a side view of the interior of the rotary stage in accordance with one embodiment of the present invention;

FIG. 8 is a side view of the interior of the rotary stage in accordance with one embodiment of the present invention;

FIG. 9 is a schematic perspective view illustrating the cutting process by the processing device on the rotary stage in accordance with one embodiment of the present invention; and

FIG. 10 is a front view of a rotary stage in accordance with another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

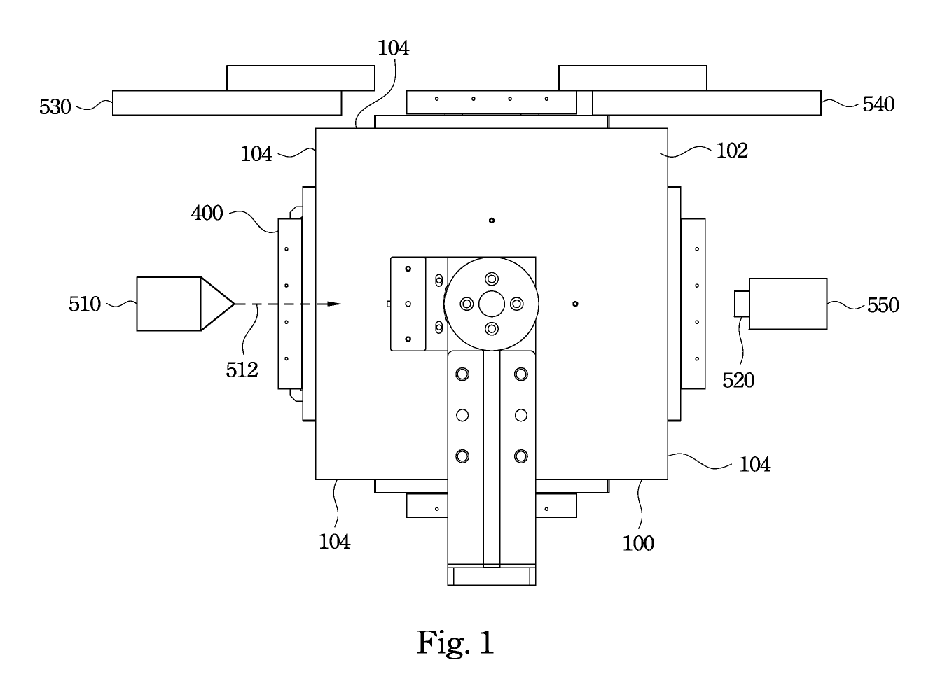

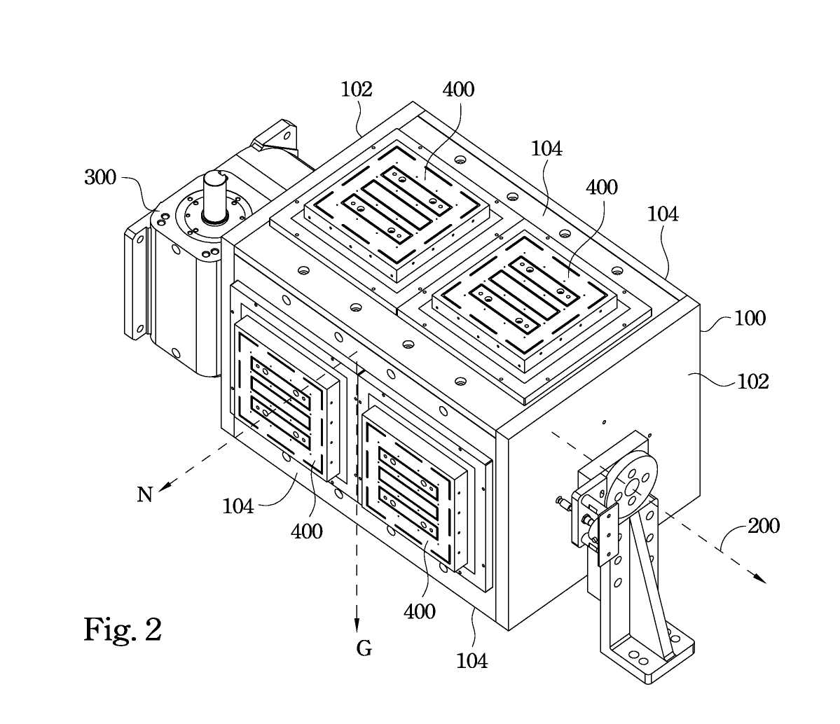

FIG. 1 is a side view of a processing system in accordance with one embodiment of the present invention. FIG. 2 is a perspective view of the rotary stage 100 of FIG. 1. As shown in FIGS. 1 and 2, the processing system includes a rotary stage 100, a rotation driver 300, a plurality of loading platforms 400 and a plurality of processing devices 510 and 520. As shown in FIG. 2, the rotary stage 100 includes two opposite end surfaces 102 and a plurality of loading surfaces 104 between the end surfaces 102. The loading platforms 400 are respectively disposed on the loading surfaces 104 of the rotary stage 100. The processing devices 510 and 520 (See FIG. 1) are respectively disposed adjacent to the loading platforms 400.

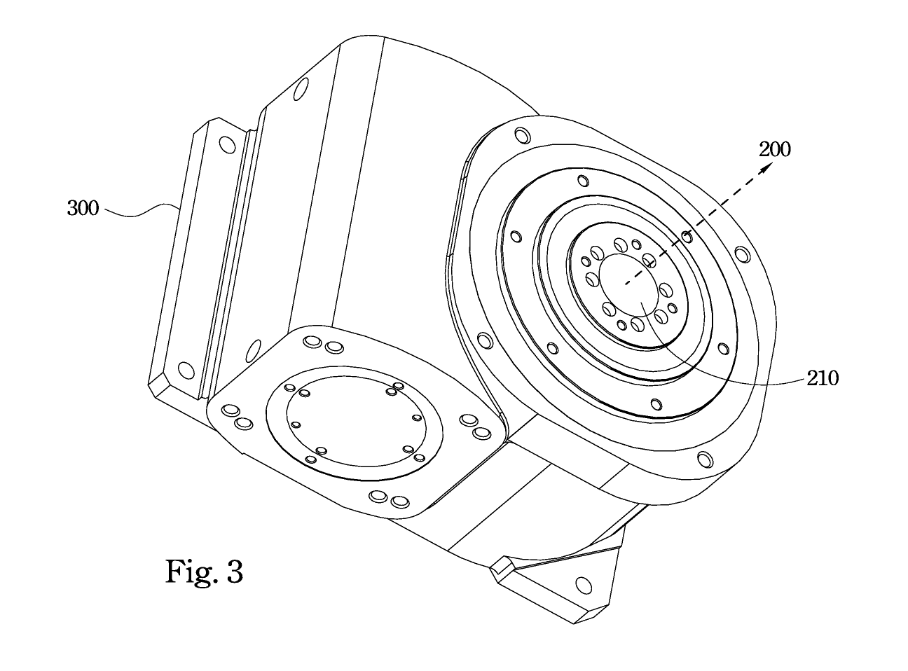

FIG. 3 is a perspective view of the rotation driver 300 of FIG. 2. As shown in FIG. 3, the processing system includes a shaft 210 connected to the rotation driver 300. The shaft 210 is connected to the end surfaces 102 of the rotary stage 100 (See FIG. 2). When the rotation driver 300 drives the shaft 210 to rotate, the shaft 210 can lead the end surface 102 rotate, thereby rotating the rotary stage 100.

As shown in FIG. 3, the shaft 210 has an axial direction 200. The axial direction 200 refers to an extension of the central axis of the shaft 210. As shown in FIG. 2, the axial direction 200 of the shaft 210 intersects to a gravity direction G. In other words, the axial direction 200 is not parallel to the gravity direction G. When the rotation driver 300 drives the shaft 210 to rotate, and thereby rotating the rotary stage 100 along the axial direction 200, each loading surfaces 104 can rotates to different level heights, rather than rotating on a constant level height, so that the space for processing can be reduced. For example, the rotary stage 100 in FIG. 2 can be a cube, namely, the rotary stage 100 includes six surfaces, in which two of them are end surfaces 102, and four of them are loading surfaces 104 connected between the end surfaces 102. The upward loading surface 104 can rotate from the upward direction to the rightward direction, and then, the loading surface 104 can rotate to the downward direction, and then, the loading surface 104 can be rotated to the leftward direction, and then, the loading surface 104 can rotate back to the upward direction.

It is understood that the rotary stage 100 is not limited to cube-shaped. In other embodiments, the rotary stage 100 can be any polyhedron, such as a triangular prism, a pentagonal prism or a hexagonal prism. It is understood that the “gravity direction G” in this context refers to the path that an object free falls. It is understood that the “upward direction”, the “downward direction”, the “rightward direction” and the “leftward direction” in this context are only used to assist the reader to understand the present invention, but do not mean that the element faces to any particular direction in practice.

In some embodiments, as shown in FIG. 2, a single loading surface 104 has plural loading platforms 400 disposed thereon. These loading platforms 400 can be arranged along the axial direction 200. If the amount of the objects to be processed is increased, additional loading platforms 400 can be arranged along the axial direction 200, and therefore, the radius of the rotary stage 100 has not to be increased, so that the processing accuracy are not influenced.

In some embodiments, as shown in FIG. 1, the processing device 510 is adjacent to the leftward loading surface 104, and the processing device 520 is adjacent to the rightward loading surface 104. Alternatively, a loading machine 530 and an unloading machine 540 are adjacent to the upward loading surface 104. Because the loading surfaces 104 are located on different level heights, the processing devices 510 and 520 can be positioned on the level height different from the loading machine 530 and the unloading machine 540, thereby reducing the space for the processing. For example, the tops of the processing devices 510 and 520 can be lower than the bottoms of the loading machine 530 and the unloading machine 540.

In some embodiments, as shown in FIG. 1, the processing device 510 is a laser source. The laser source has an emission direction 512. The emission direction 512 passes through one of the loading surfaces 104. In particular, the emission direction 512 of the processing device 510 (the laser source) passes through the loading platform 400 on the loading surface 104, so that the processing device 510 can cut the object (not shown) on the loading platform 400.

In some embodiments, as shown in FIGS. 1 and 2, the loading surface 104 that the emission direction 512 passes through has a normal line direction N. The normal line direction N and the gravity direction G are concurrent vectors, and define an angle 0 therebetween, in which 0°≦0≦90°. In particular, as shown in FIG. 1, the loading surface 104 adjacent to the processing device 510 is not horizontal, and the normal line direction N of this loading surface 104 is perpendicular to the gravity direction G, namely, the angle θ is 90 degrees. Therefore, when the processing device 510 cuts the object on the loading platform 400 and thereby produces dusts, the dusts can fall along the gravity direction G, so that the loading platform 400 can be cleaned. In other embodiments, the angle θ can be less than 90 degrees, so that the loading surface 104 that the emission direction 512 passes through can be further inclined downwardly, thereby assisting the dusts to fall more effectively.

It is understood that concurrent vectors refer that two vectors, not parallel to each other, share a common tail. The angle θ refers to the angle between the heads of these two vectors relative to the common tail.

In some embodiments, as shown in FIG. 1, the processing device 520 is an image capturing device. The image capturing device and the processing device 510 (the laser source) are respectively disposed on opposite sides of the rotary stage 100. In other words, the rotary stage 100 is positioned between the processing device 510 and the processing device 520. The processing system alternatively includes a calibration device 550. The calibration device 550 is electrically connected to the processing device 520 (the image capturing device) and the processing device 510 (the laser source). The processing device 520 is used for capturing an image of the object on the loading surface 104 adjacent to the processing device 520. The calibration device 550 can be used for calibrating a path of the processing device 510 according to that image. Therefore, even though the object to be processed moves relative to the loading platform 400 when the rotary stage 100 rotates, the calibration device 550 can make the processing device 510 cut the correct pattern. In some embodiments, the image capturing device can be, but is not limited to be, a Charge-coupled Device (CCD).

In some embodiments, as shown in FIG. 1, the loading machine 530 is used for putting at least one object to be projected on the loading surface 104 perpendicular to the gravity direction G (See FIG. 2). In other words, the loading surface 104 adjacent to the loading machine 530 is horizontal, thereby preventing the object thereon from falling. In some embodiments, the loading machine 530 can be, but is not limited to be, a robotic arm.

In some embodiments, as shown in FIG. 1, the unloading machine 540 is used for removing at least one processed object on the loading surface 104 perpendicular to the gravity direction G. In other words, the loading surface 104 adjacent to the unloading machine 540 is horizontal. In some embodiments, the unloading machine 540 can be, but is not limited to be, a robotic arm.

In some embodiments, the loading machine 530 and the unloading machine 540 work synchronously. In other words, when the unloading machine 540 removes the processed object, the loading machine 530 can simultaneously put the object to be processed on the loading surface 104, so as to increase the processing speed.

In some embodiments, the loading surface 104 adjacent to the loading machine 530 and the unloading machine 540 faces upwardly. When the loading machine 530 puts the object to be processed on the upward loading surface 104, the rotary stage 100 rotates, such that the loading surface 104 rotates to the rightward direction. At this time, the processing device 520 (the image capturing device) captures the image of the object on the rightward loading surface 104. The calibration device 550 calibrates the path of the processing device 510 (the laser source) according to the image. Then, the rotary stage 100 rotates, and the loading surface 104 rotates to the downward direction, and then rotates to the leftward direction. At this time, the processing device 510 (the laser source) cuts the object on the leftward loading surface 104. Finally, the rotary stage 100 rotates, and the loading surface 104 rotates back to the upward direction. At this time, the unloading machine 540 removes the processed object from the rotary stage 100.

In some embodiments, the processing system may alternatively not include the loading machine 530 and the unloading machine 540. Instead, the manufacturer may manually load and unload the object.

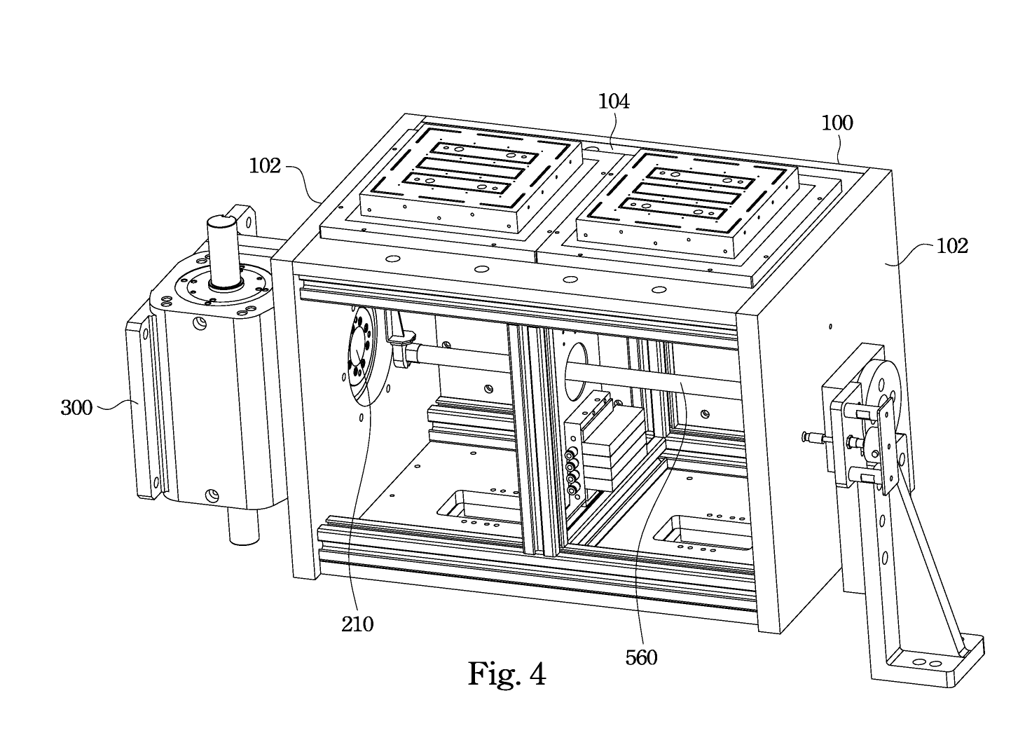

FIG. 4 is a perspective view of the interior of the rotary stage 100 in accordance with one embodiment of the present invention. In some embodiments, as shown in FIG. 4, the processing system alternatively includes a light source 560 positioned in the rotary stage 100 for providing light to the processing device 520 (the image capturing device, referring to FIG. 1), so as to facilitate the processing device 520 to capture images. Moreover, in order that the light emitted by the light source 560 can propagate out of the rotary stage 100, the loading surface 104 is preferably light-transmissive.

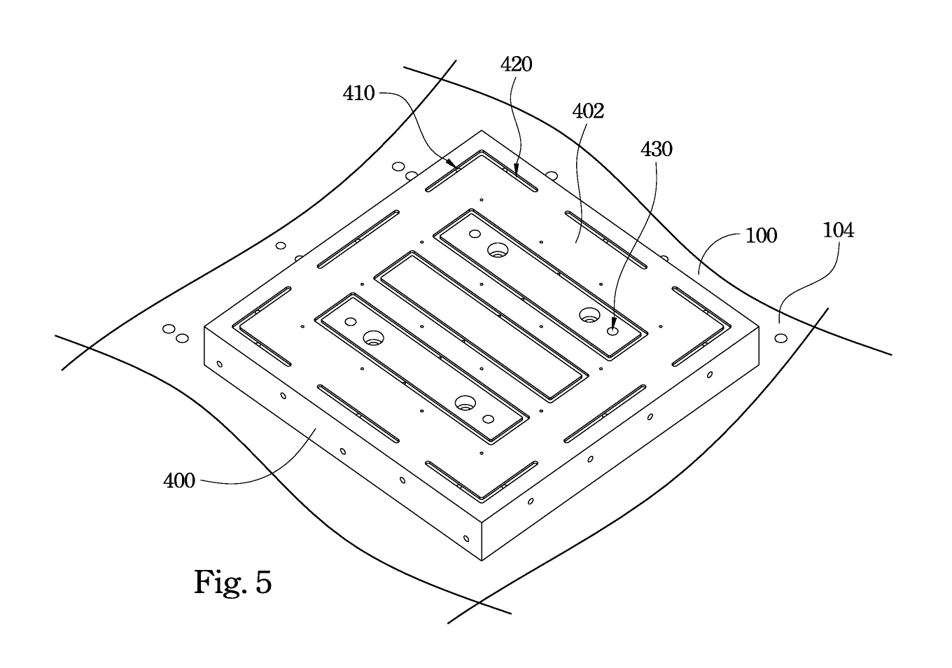

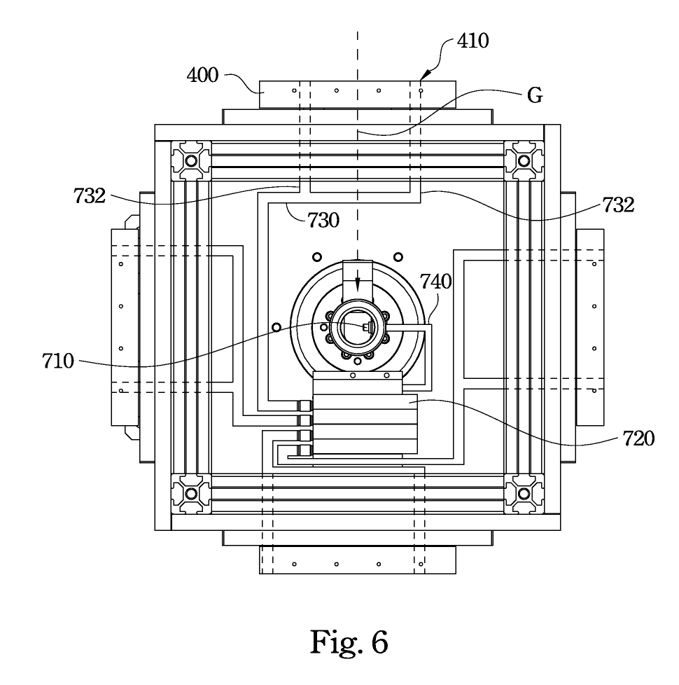

FIG. 5 is a perspective view of the loading platform 400 in accordance with one embodiment of the present invention. In some embodiments, as shown in FIG. 5, each loading platform 400 includes a processing surface 402 and at least one vacuum hole 410. The processing surface 402 is opposite to the rotary stage 100. The vacuum hole 410 is positioned on the processing surface 402. Plural vacuum holes 410 are preferably distributed on different edges of the processing surface 402, so as to fasten the object to be processed. FIG. 6 is a front view of the interior of the rotary stage 100 in accordance with one embodiment of the present invention. In some embodiments, as shown in FIG. 6, the processing system alternatively includes a vacuum source 710 connected to the vacuum holes 410 of the loading platforms 400, so as to provide vacuum force to the vacuum holes 410 of each loading platform 400.

In particular, as shown in FIGS. 5 and 6, the object to be processed can be placed on the processing surface 402 and can cover the vacuum holes 410. The vacuum holes 410 are through holes formed on the processing surface 402, and are in spatial communication with the vacuum source 710. Hence, the vacuum source 710 can suck the object on the processing surface 402 through the vacuum holes 410, thereby preventing the objects escaping out of the processing surface 402 when the rotary stage 100 rotates.

In some embodiments, as shown in FIG. 5, each loading platform 400 has at least one vacuum groove 420. The vacuum groove 420 is positioned on the processing surface 402. The vacuum holes 410 are positioned on an inner wall of the vacuum groove 420. In particular, each vacuum groove 420 can be rectangular or L-shaped. The vacuum grooves 420 construct a substantial rectangular outline, and the vacuum holes 410 can be positioned on the any location of the inner wall of the vacuum groove 420. When the object is placed on the processing surface 402 and covers the vacuum groove 420, the vacuum source 710 draws the air in the vacuum groove 420 away, thereby fastening the object more steadily.

In some embodiments, as shown in FIG. 6, the processing system alternatively includes a plurality of solenoid valves 720 respectively connected between the vacuum source 710 and the vacuum holes 410 of the loading platforms 400. The solenoid valves 720 can allow or block the spatial communication between the vacuum source 710 and the vacuum holes 410. For example, when the loading platform 400 faces upwardly, the solenoid valve 720 may block the spatial communication between the vacuum source 710 and the vacuum holes 410 of this upward loading platform 400, so that the unloading machine 540 can remove the processed object easily.

Each solenoid valve 720 employs a vacuum connection pipe 730 to spatially communicate with the vacuum holes 410. Each vacuum connection pipe 730 includes plural manifolds 732 to spatially communicate with the vacuum holes 410 in the loading platform 400. The vacuum source 710 may employ at least one vacuum supply pipe 740 to connect to the solenoid valve 720.

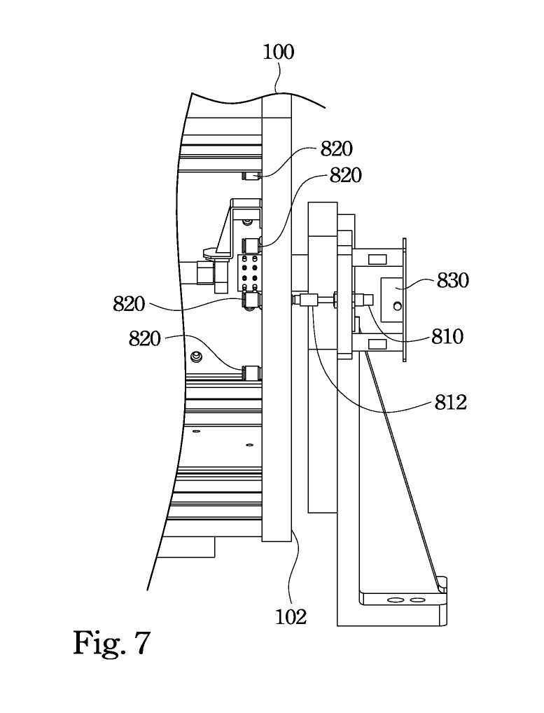

FIG. 7 is a side view of the interior of the rotary stage 100 in accordance with one embodiment of the present invention. In some embodiments, as shown in FIG. 7, the processing system alternatively includes a suction source 810 and a plurality of suction faucets 820. The suction source 810 is alternatively in spatial communication with at least one of the suction faucets 820. Referring to FIG. 5, each loading platform 400 includes at least one suction hole 430. The suction faucets 820 are respectively in spatial communication with the suction holes 430 of the loading platforms 400. In other words, different suction faucets 820 correspond to suction holes 430 of the loading platforms 400 on different loading surfaces 104. When the suction source 810 is in spatial communication with one suction faucet 820, the suction holes 430 on the loading surface 104 corresponding to this suction faucet 820 draw dusts away, thereby achieving the dust cleaner effect.

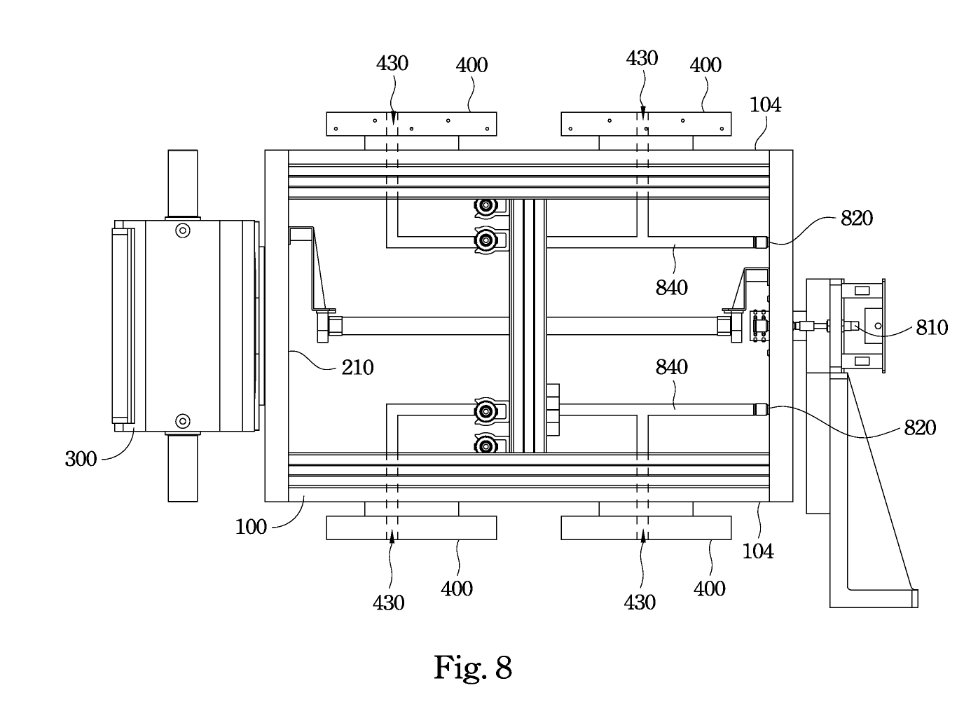

FIG. 8 is a side view of the interior of the rotary stage 100 in accordance with one embodiment of the present invention. In some embodiments, as shown in FIG. 8, each suction faucet 820 can be spatially communicated with one suction pipe 840. Different suction pipes 840 are spatially communicated with the suction holes 430 on different loading surfaces 104. Therefore, by choosing a suction faucet 820, the dusts on the corresponding loading surface 104 can be drawn away.

In some embodiments, the suction source 810 is used for the processing device 510 (See FIG. 1). The suction source 810 is spatially communicated with the suction holes 430 of the loading platform 400 adjacent to the processing device 510 through one suction faucet 820. In particular, the suction source 810 is in spatial communication with the suction holes 430 on the loading surface 104 that faces to the processing device 510 (the laser source). Therefore, when the processing device 510 cuts the object and produces dusts, the suction source 810 can draw these dusts away.

Reference is now made to FIG. 7. In some embodiments, the processing system alternatively includes an actuator 830. The actuator 830 is connected to the suction source 810 for pushing the suction source 810 to alternatively be in spatial communication with at least one of the suction faucets 820. In particular, the suction source 810 includes a movable faucet 812. The actuator 830 can drive the movable faucet 812 to spatially communicate with the suction faucet 820, or to spatially separate from suction faucet 820. For example, the actuator 830 and the movable faucet 812 can be the magnetic components, and the actuator 830 can utilize the magnetic force to drive the movable faucet 812 to move forwards or backwards, so that the movable faucet 812 can be spatially communicated with, or spatially separated from the suction faucet 820. When the rotary stage 100 starts to rotate, the actuator 830 can drive the movable faucet 812 to spatially separate from the suction faucet 820 of the processing device 510, so as to prevent dragging the suction pipe 840 (See FIG. 8) due to the rotation. When the rotary stage 100 rotates, and the next suction faucet 820 arrives the position near the processing device 510, the actuator 830 can drive the movable faucet 812 to spatially communicate with this suction faucet 820 near the processing device 510.

In some embodiments, the suction source 810 can be, but is not limited to be, a vacuum suction device. In other embodiments, the suction source 810 can be any device capable of drawing the air away.

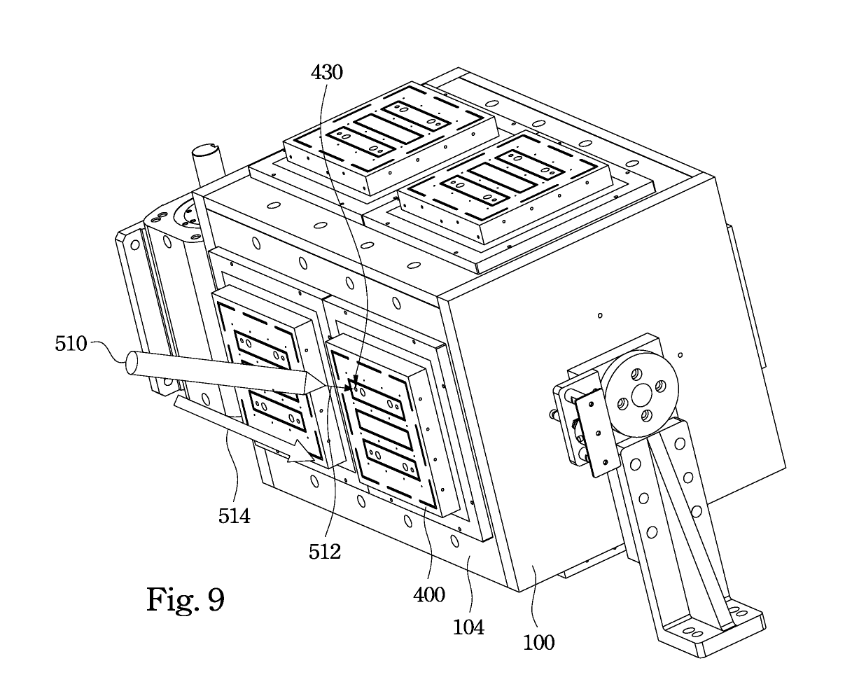

FIG. 9 is a schematic perspective view illustrating the cutting process by the processing device 510 on the rotary stage 100 in accordance with one embodiment of the present invention. As shown in FIG. 9, the path 514 of the processing device 510 (the laser source) leads the emission direction 512 of the processing device 510 to pass through the suction hole 430. Hence, the dusts produced by cutting the object can directly fall into the suction hole 430, and can be drawn away quickly.

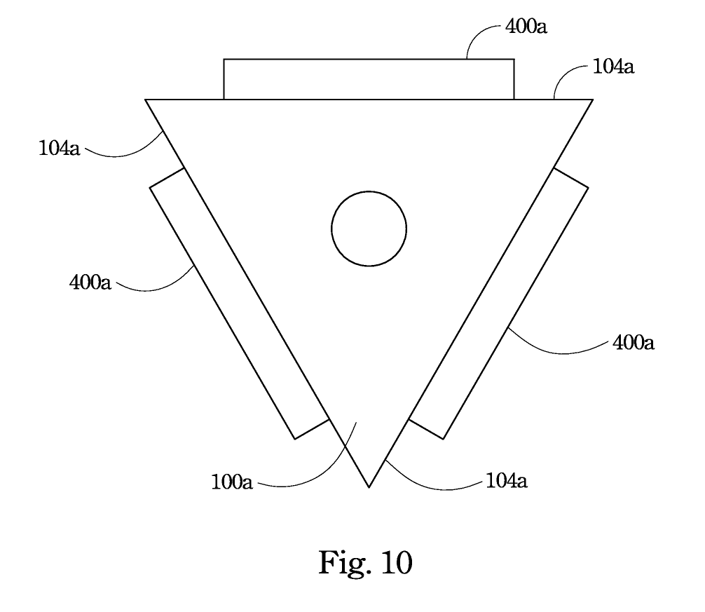

FIG. 10 is a front view of a rotary stage 100a in accordance with another embodiment of the present invention. The main difference between this embodiment and FIG. 2 is that: the rotary stage 100a is a triangular prism, not the cube as shown in FIG. 2. In particular, the loading surfaces 104a construct a triangle in the front view. Each loading surface 104a has a loading platform 400a thereon for supporting the object to be processed. In this embodiment, the loading and unloading machines (not shown) are positioned adjacent to the upward loading surface 104a, and the laser source (not shown) is positioned adjacent to the loading surface 104a facing toward the lower left direction, and the image capturing device (not shown) is positioned adjacent to the loading surface 104a facing toward the lower right direction.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A processing system, comprising:
a rotary stage having two opposite end surfaces and a plurality of loading surfaces between the end surfaces;
at least one shaft connected to the end surfaces of the rotary stage;
a rotation driver connected to the shaft;
a plurality of loading platforms respectively disposed on the loading surfaces of the rotary stage; and
a plurality of processing devices respectively disposed adjacent to the loading platforms.

2. The processing system of claim 1, wherein the shaft intersects to a gravity direction.

3. The processing system of claim 1, wherein one of the processing devices is a laser source, and the laser source has an emission direction which passes through one of the loading surfaces.

4. The processing system of claim 3, wherein the loading surface that the emission direction passes through has a normal line direction, wherein the normal line direction and a gravity direction are concurrent vectors and define an angle θ therebetween, wherein 0°≦θ≦90°.

5. The processing system of claim 3, wherein another one of the processing devices is an image capturing device, wherein the image capturing device and the laser source are respectively disposed on opposite sides of the rotary stage.

6. The processing system of claim 5, further comprising:
a calibration device electrically connected to the image capturing device and the laser source for calibrating a path of the laser source according to the image.

7. The processing system of claim 5, further comprising:
a light source positioned in the rotary stage.

8. The processing system of claim 1, further comprising:
a loading machine, wherein one of the loading surfaces is perpendicular to a gravity direction, and the loading machine is used for putting at least one object to be processed on the loading surface perpendicular to the gravity direction.

9. The processing system of claim 1, further comprising:
an unloading machine, wherein one of the loading surfaces is perpendicular to a gravity direction, and the unloading machine is used for removing at least one processed object on the loading surface perpendicular to the gravity direction.

10. The processing system of claim 1, wherein each of the loading platforms comprises a processing surface and at least one vacuum hole, wherein the processing surface is opposite to the rotary stage, and the vacuum hole is positioned on the processing surface; and the processing system further comprises a vacuum source connected to the vacuum holes of the loading platforms.

11. The processing system of claim 10, further comprising:
a plurality of solenoid valves respectively connected between the vacuum source and the vacuum holes of the loading platforms.

12. The processing system of claim 10, wherein each of the loading platforms has at least one vacuum groove, wherein the vacuum groove is positioned on the processing surface, wherein the vacuum hole is positioned on an inner wall of the vacuum groove.

13. The processing system of claim 1, further comprising:
a suction source; and
a plurality of suction faucets, the suction source being alternatively in spatial communication with at least one of the suction faucets, wherein each of the loading platforms comprises at least one suction hole, and the suction faucets are respectively in spatial communication with the suction holes of the loading platforms.

14. The processing system of claim 13, further comprising:
an actuator connected to the suction source for pushing the suction source to alternatively be in spatial communication with at least one of the suction faucets.

15. The processing system of claim 13, wherein one of the processing devices is a laser source, and the suction source is in spatial communication with the suction hole of the loading platform adjacent to the laser source through one of the suction faucets.
